(19) United States
(12) Patent Application Publication
(10) Pub. No.: US 2026/0348822 A1
(43) Pub. Date: Nov. 5, 2026

(54) DEVICES AND METHODS FOR RAPID DETECTION OF MICROPLASTIC NUMBER CONCENTRATION BASED ON ON-CHIP IMAGING

(71) Applicant: SOUTHEAST UNIVERSITY, Nanjing (CN)

(72) Inventors: Yu SU, Nanjing (CN); Chenqi YANG, Nanjing (CN)

(73) Assignee: SOUTHEAST UNIVERSITY, Nanjing (CN)

(21) Appl. No.: 19/707,512

(22) Filed: Jun. 15, 2026

Related U.S. Application Data
(63) Continuation-in-part of application No. PCT/CN2024/071253, filed on Jan. 9, 2024.

(30) Foreign Application Priority Data
Dec. 14, 2023 (CN) 202311720404.3

(51) Int. Cl. G01N 15/075; G01N 15/0227; G06T 7/00; G06T 7/13

(52) U.S. Cl. CPC G01N 15/075; G01N 15/0227; G06T 7/001; G06T 7/13; G06T 2207/10016; G06T 2207/10056; G06T 2207/20081; G06T 2207/30148

(57) ABSTRACT

Provided is a device and method for rapid detection of microplastic number concentration based on on-chip imaging. The method includes: under a clean environmental condition, placing a microplastic sample to be tested in a sample loading region on a surface of an image sensor chip, and standing; turning on a light source, and acquiring a shadow image of microplastics deposited in the sample loading region of the image sensor chip; analyzing the shadow image in a manual analysis manner or a machine learning manner to obtain a microplastic sample image, counting the microplastic sample image, and calculating the microplastic number concentration; dropping anhydrous ethanol onto the sample loading region, wiping off the microplastics deposited on the surface of the sample loading region of the image sensor chip, and acquiring a shadow image to inspect cleanliness. The cleanliness is used for detection of a next batch of microplastic samples.

### CROSS-REFERENCE TO RELATED APPLICATIONS

This application is a Continuation-in-part of International Application No. PCT/CN2024/071253, filed on Jan. 9, 2024, which claims priority to Chinese Patent Application No. 202311720404.3, filed on Dec. 14, 2023, the entire contents of each of which are hereby incorporated by reference.

### TECHNICAL FIELD

The present disclosure relates to the field of environmental emerging pollutant treatment technology, and in particular to a device and a method for rapid detection of microplastic number concentration based on on-chip imaging.

### BACKGROUND

Microplastics are emerging contaminants of international focus, and are also a class of new pollutants explicitly targeted for treatment by the Chinese government in the “Action Plan for the Treatment of Emerging Contaminants.” An important prerequisite for achieving precise prevention and control of microplastic pollution is to promptly obtain reliable data on pollution status of the microplastics. However, after the microplastics are separated from environmental media, rapid analysis of microplastic number concentration remains a key methodological challenge.

Typically, to visually check whether the microplastics exist in a processed sample and to analyze a count and size of the microplastics, the processed sample needs to be first filtered onto a surface of a filter membrane, and then observed and analyzed under a conventional optical microscope. Because a conventional (lensed) optical microscope cannot achieve both a wide field of view and high-resolution imaging, it is difficult to manually obtain an image of the entire filter membrane at high magnification and to count all particulate matter retained by the filter membrane. Although an automated optical microscope can capture an image of the entire filter membrane with the aid of a motorized stage, autofocus, and image stitching techniques, the process is time-consuming (several tens of minutes). Furthermore, a pixel size and a count of pixels of an image sensor configured therein are limited, and an observer can only identify and measure particulate matter >30 μm from the image of the entire filter membrane, thus missing microplastics of small sizes. Consequently, lensed optical microscopic imaging techniques are time-consuming and have low accuracy for microplastic detection. Therefore, it is urgent to establish new methods to improve efficiency and reliability of imaging and counting microplastic samples.

Lensless holographic imaging is considered to have application prospects in microplastic detection, but a sensor of this technology acquires a coherent diffraction pattern of a sample, and requires the use of a reconstruction algorithm to restore phase information of the sample, also cannot directly and quickly obtain an optical image of the microplastic sample.

Therefore, there is an urgent need to establish a device and a method for rapid detection of microplastic number concentration based on on-chip imaging, capable of applying lensless optical imaging technology to detection of microplastic number concentration, overcoming a bottleneck problem that existing analysis manners for microplastics are difficult to directly and quickly acquire a wide-field, high-resolution image of a sample.

### SUMMARY

Embodiments of the present disclosure provide a device for rapid detection of microplastic number concentration based on on-chip imaging. The device comprises a light source, an image sensor chip, a control system, and an image processing component. The control system is respectively connected to the light source, the image sensor chip, and the image processing component. The light source is vertically arranged above the image sensor chip. The control system is connected to the image processing component via a data transmission line. A sample loading region is provided on an upper surface of the image sensor chip, and a microplastic sample to be tested is placed in the sample loading region.

In some embodiments, the light source is monochromatic light or polychromatic light.

In some embodiments, a wavelength of the light source is 300 nm to 700 nm.

In some embodiments, a vertical distance from the light source to the image sensor chip is 5 cm to 10 cm.

In some embodiments, a photosensitive region of the image sensor chip has a length of 10 mm to 20 mm and a width of 10 mm to 20 mm, a pixel size is 0.5 μm to 1 μm, and a count of pixels is 100 million to 1.6 billion.

In some embodiments, a vertical distance from the microplastic sample to be tested to the image sensor chip is 5 μm to 10 μm.

In some embodiments, the sample loading region is a square region enclosed by cured adhesive, the sample loading region has a length of 10 mm to 20 mm and a width of 10 mm to 20 mm, a volume of the sample loading region is 100 μL to 400 μL, and a height of the sample loading region is 0.5 mm to 1.5 mm.

Embodiments of the present disclosure provide a method for rapid detection of microplastic number concentration based on on-chip imaging. The method comprises following steps: step (1), under a clean environmental condition, placing a microplastic sample to be tested in a sample loading region on a surface of an image sensor chip, and allowing the microplastic sample to be tested to stand; step (2), turning on a light source, and acquiring a shadow image of microplastics deposited on a surface of the sample loading region of the image sensor chip as a deposition shadow image; step (3), analyzing the deposition shadow image acquired by a manual analysis manner or a machine learning manner, performing counting and calculating the microplastic number concentration; step (4), dropping anhydrous ethanol onto the sample loading region, wiping off the microplastics deposited on the surface of the sample loading region of the image sensor chip, and acquiring a shadow image of the sample loading region as an inspection shadow image for inspecting cleanliness of the surface of the sample loading region. The cleanliness of the surface of the sample loading region is used for detection of a next batch of microplastic samples to be tested.

In some embodiments, in step (1), the microplastic sample to be tested is a suspension.

In some embodiments, in step (1), standing time is 90 s or more.

In some embodiments, in step (1), the clean environmental condition is a cleanroom or an ultra-clean workbench, and a cleanliness is class 100 (ISO 5) (a particle count ≥1 μm is 832 particles/m³) or above.

In some embodiments, mass concentration of the suspension is less than 100 mg/L, and a volume of the suspension added to the sample loading region is 100 μL to 400 μL.

In some embodiments, in step (2), the light source is a light emitting diode (LED).

In some embodiments, in step (2), time for acquiring the deposition shadow image is 90 s or more.

In some embodiments, in step (3), the manual analysis manner is to import the deposition shadow image into image processing software, and manually mark and count the microplastics. The machine learning manner is to automatically recognize and count the microplastics in the deposition shadow image by constructing and training a mathematical model. The mathematical model is a target keypoint detection algorithm based on an existing model and after training and testing. A size of markable or identifiable microplastics is 3 μm to 6 μm.

In some embodiments, in step (4), the wiping off of the microplastics deposited on the surface of the sample loading region of the image sensor chip includes: using a disposable lint-free swab to absorb waste liquid, and then using a dry disposable lint-free swab to wipe the image sensor chip, and the cleanliness is a particle count <10 particles/cm².

### BRIEF DESCRIPTION OF THE DRAWINGS

To more clearly illustrate the technical solutions of the embodiments of the present application or the prior art, the drawings required for describing the embodiments or the prior art will be briefly introduced below. Obviously, the drawings in the following description are merely embodiments of the present application, and for a person of ordinary skill in the art, other drawings may also be obtained based on the provided drawings without creative effort.

FIG. 1 is a schematic diagram illustrating a structure of a device for rapid detection of microplastic number concentration based on on-chip imaging according to some embodiments of the present disclosure; in FIG. 1: 1. a light source; 2. an image sensor chip; 3. a control system; 4. a data transmission line; 5. an image processing component;

FIG. 2 is a flowchart illustrating an exemplary process of a method for rapid detection of microplastic number concentration according to some embodiments of the present disclosure;

FIG. 3 is a lensless shadow microscopic full-field image of polyethylene microplastics acquired in Example 2 of the present disclosure;

FIG. 4 is a partial enlarged view of region S1 in FIG. 3;

FIG. 5 is a partial enlarged view of region S2 in FIG. 4;

FIG. 6 is a schematic diagram illustrating a lensed optical microscopic image of polyethylene microplastics acquired in Example 2 of the present disclosure;

FIG. 7 is a comparison chart of diameter statistical results from lensless shadow microscopic imaging and lensed optical microscopic imaging of polyethylene microplastics in Example 2 of the present disclosure;

FIG. 8 is a schematic diagram illustrating an effect of standing time on number concentration of melamine microfibers in Example 3 of the present disclosure;

FIG. 9 is a schematic diagram illustrating an effect of standing time on a length distribution of melamine microfibers in Example 3 of the present disclosure.

### DETAILED DESCRIPTION

The technical solutions of the present disclosure are further described below with reference to the drawings.

Some embodiments of the present disclosure employ lensless shadow imaging. The lensless shadow imaging is a ‘what you see is what you get’ imaging manner, whereby shadows generated by a microplastic sample in a sample loading region of an image sensor chip are directly formed into an image after being recorded by a sensor. An imaging field of view and resolution depend on a count of pixels and a pixel size of the image sensor chip, and a distance from the microplastic sample to the image sensor chip. In some embodiments of the present disclosure, by employing the image sensor chip with a small pixel size and a high count of pixels, rapid detection of microplastic number concentration is achieved based on lensless shadow imaging technology.

### Example 1

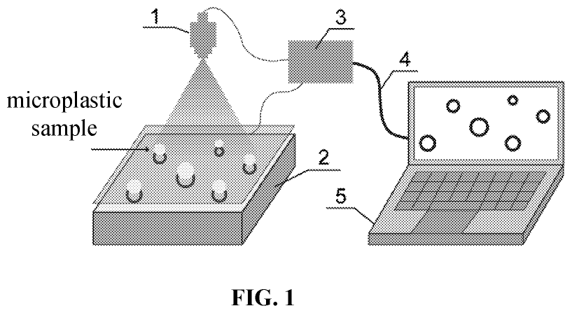

FIG. 1 is a schematic diagram illustrating a structure of a device for rapid detection of microplastic number concentration based on on-chip imaging according to some embodiments of the present disclosure.

In some embodiments, as shown in FIG. 1, the device for rapid detection of microplastic number concentration based on on-chip imaging includes a light source 1, an image sensor chip 2, a control system 3, and an image processing component 5. The control system 3 is respectively connected to the light source 1, the image sensor chip 2, and the image processing component 5. The light source 1 is vertically arranged above the image sensor chip 2. The control system 3 is connected to the image processing component 5 via a data transmission line 4. A sample loading region is provided on an upper surface of the image sensor chip 2, and a microplastic sample to be tested is placed in the sample loading region.

The light source 1 refers to a light-emitting device capable of generating illumination light. For example, the light source 1 may be a light emitting diode (LED), a laser diode, or the like.

In some embodiments, the light source is monochromatic or polychromatic light. A wavelength of the light source is 300 nm to 700 nm. A vertical distance from the light source to the image sensor chip is 5 cm to 10 cm.

The image sensor chip 2 refers to a chip configured to convert an optical signal into image data, such as a Complementary Metal Oxide Semiconductor (CMOS) image sensor chip, a Charge-Coupled Device (CCD) image sensor chip, an image sensor chip based on Vertical Transfer Imaging Device technology, or the like.

In some embodiments, the upper surface of the image sensor chip is a photosensitive surface.

In some embodiments, the image sensor chip includes a photosensitive region. The photosensitive region refers to a specific region configured to sense light and convert the light into an electrical signal. The photosensitive region of the image sensor chip has a length of 10 mm to 20 mm and a width of 10 mm to 20 mm. A pixel size is 0.5 μm to 1 μm. A count of pixels is 100 million to 1.6 billion. A vertical distance between the microplastic sample to be tested and the image sensor chip is 5 μm to 10 μm.

The microplastic sample to be tested refers to a liquid turbid suspension or a suspension containing microplastic particles. The microplastic particles (also referred to as microplastics) refer to solid plastic particles in the microplastic sample to be tested, and are target objects for detection in the present disclosure. In some embodiments, a particle size of the microplastic particles is at a micrometer to millimeter level. For example, the microplastic particles may be polyethylene microspheres (with a diameter of about 10 μm to 20 μm), melamine microfibers (with a length of about 1 μm to 200 μm), or the like.

The control system 3 refers to a system configured to control and drive a detection process. In some embodiments, the control system 3 may include a processor.

The processor refers to a component configured to process data and generate instructions. For example, the processor may be a Central Processing Unit (CPU), a Graphics Processing Unit (GPU), an Application-Specific Integrated Circuit (ASIC), or the like, or any combination thereof. The data may be from different components of the device for rapid detection of microplastic number concentration based on on-chip imaging or other external data sources. The instructions may be sent to the aforementioned different components. The processor may also include other components related to aforementioned content. For example, the processor may also refer to a computer, a server, a circuit board with computing functionality, or the like.

The image processing component 5 refers to a component configured to process images. In some embodiments, the image processing component 5 may include image processing software and/or image processing hardware, configured to display, analyze, and process acquired images.

The sample loading region refers to a region located on the upper surface of the image sensor chip, configured to carry and fix the microplastic sample to be tested. In some embodiments, the sample loading region may be determined based on a preset.

In some embodiments, the sample loading region is a square region enclosed by cured adhesive. The sample loading region has a length of 10 mm to 20 mm and a width of 10 mm to 20 mm. A volume of the sample loading region is 100 μL to 400 μL. A height of the sample loading region is 0.5 mm to 1.5 mm.

In some embodiments, a projection of the microplastic sample to be tested in the sample loading region of the image sensor chip 2, under vertical illumination of the light source 1, is directly recorded by the image sensor chip 2 and converted into an electrical signal. The control system 3 drives and controls the light source 1 and the image sensor chip 2 to operate, receives the electrical signal output from the image sensor chip 2, and then sends the electrical signal to the image processing component 5 via the data transmission line 4 to display shadow images of the microplastics.

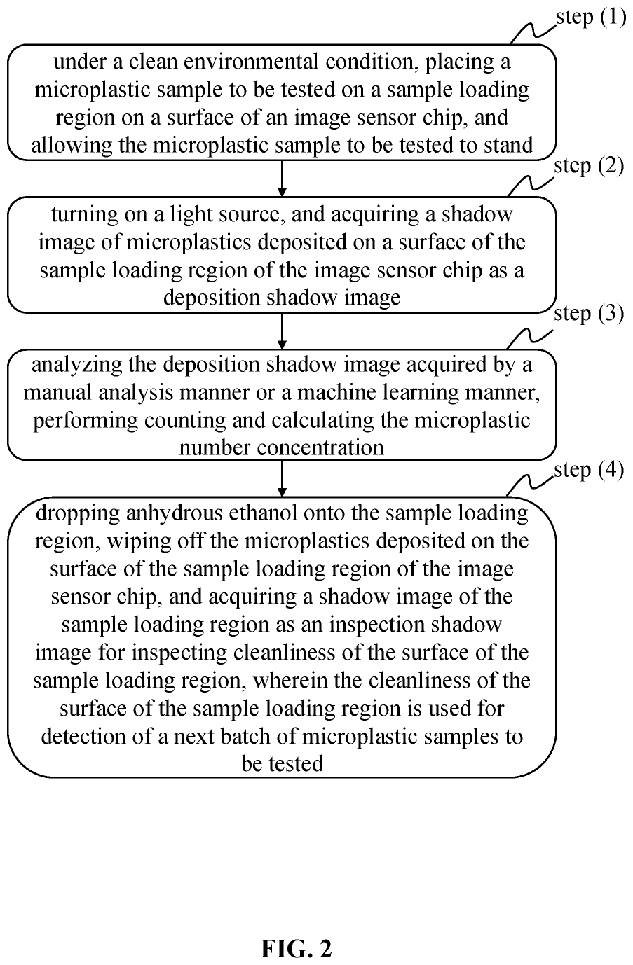

In some embodiments, a region in a shadow image where grayscale values are all lower than a background threshold is a shadow. The background threshold may be determined based on a preset. More descriptions regarding the shadow image may be found elsewhere in the present disclosure (e.g., FIG. 2 and related descriptions thereof).

The data transmission line 4 refers to a component configured for data transmission between the image processing component 5 and the control system 3.

The device for rapid detection of microplastic number concentration based on on-chip imaging, as shown in some embodiments of the present disclosure, is applicable to microplastic pure products or samples extracted from environmental media, and can rapidly determine the microplastic number concentration. An operation process is simple and easy to promote. Furthermore, the present disclosure addresses a significant demand for national new pollutant governance, significantly shortens time cost for microplastic sample imaging, is characterized by low carbon and energy saving, and responds to national policies on energy conservation and low carbon emissions. The device for rapid detection of microplastic number concentration based on on-chip imaging, as shown in some embodiments of the present disclosure, is also applicable to imaging and counting of particles other than microplastics.

In the present disclosure, the particles refer to a general term for all tiny objects deposited on the upper surface of the image sensor chip, including the microplastic particles, microbubbles, dust, or the like. The microplastic particles (also referred to as microplastics) refer to solid plastic particles in the microplastic sample to be tested, and are the target objects for detection in the present disclosure. The microbubbles refer to tiny bubbles generated in the microplastic sample to be tested due to stirring or sample addition operations, which may form shadows similar to microplastic particles in the shadow image, and are disturbing particles that need to be identified and eliminated. The dust refers to non-plastic solid impurities from an environment that fall into the sample loading region, and also belongs to disturbing particles. Solid particles refer to all solid-state particles, including the microplastic particles and the dust, but excluding the microbubbles.

That is, in the microplastic sample to be tested, in addition to the microplastic particles serving as detection targets, interfering particles such as the microbubbles may also be present. The shadows formed by the microbubbles in the shadow image are similar to the shadows of the microplastic particles, thereby easily causing a higher counting result. The present embodiment identifies and eliminates the microbubbles based on a variation in shadow area before and after thermal excitation.

In some embodiments, the device for rapid detection of microplastic number concentration based on on-chip imaging further includes a transparent heating electrode arranged at a bottom of the sample loading region. The transparent heating electrode is arranged on the upper surface of the image sensor chip. The transparent heating electrode is electrically connected to the control system, and a refractive index of the transparent heating electrode matches that of a chip cover glass of the image sensor chip so as to allow a light beam of the light source to penetrate without loss. The control system is further configured to: after the microplastic sample to be tested has been allowed to stand for settling, turn on the light source to acquire a reference shadow image; apply a low-voltage electrical pulse of a first preset duration to the transparent heating electrode, and upon stopping application of the low-voltage electrical pulse, control the image sensor chip to acquire a heated shadow image; determine an area variation rate of a plurality of shadows based on the reference shadow image and the heated shadow image; eliminate shadows of which the area variation rate is greater than a preset swelling threshold in the reference shadow image. The first preset duration is 0.5 s to 1.5 s.

The transparent heating electrode refers to an electrode configured to heat the microplastic sample to be tested. For example, the transparent heating electrode may be a dense conductive thin film array integrated and deposited above the image sensor chip and covered over the bottom of the sample loading region, e.g., a coating made of ITO material.

In some embodiments, the transparent heating electrode may be integrated on the chip cover glass of the image sensor chip. The transparent heating electrode has high light transmittance for the light source. The transparent heating electrode may generate Joule heat when energized, and is configured to instantaneously micro-heat the microplastic sample to be tested.

In some embodiments, the refractive index of the transparent heating electrode matches that of the chip cover glass of the image sensor chip, so as to allow the light beam of the light source to penetrate without loss.

The refractive index matching refers to the refractive index of the transparent heating electrode being equal to or close to the refractive index of the chip cover glass (e.g., a refractive index difference is within ±0.05). When the light beam emitted by the light source enters the transparent heating electrode from the chip cover glass, since the refractive indices of the transparent heating electrode and the chip cover glass are consistent, the light beam hardly undergoes reflection and refraction at an interface, thereby eliminating artifact interference generated by the transparent heating electrode itself in the shadow image and avoiding brightness attenuation of the particle projection by the transparent heating electrode, which ensures accuracy of subsequent area variation rate determination.

The stand for settling refers to a process of causing the solid particles to naturally settle on a surface of the image sensor chip under gravity after the microplastic sample to be tested is dropped onto the sample loading region. In some embodiments, standing time may be determined based on a type and volume of the microplastic sample to be tested. For example, the standing time is 90 s or more.

The reference shadow image refers to a shadow image acquired after the microplastic sample to be tested is allowed to stand for settling and before a heating pulse is applied. The reference shadow image is configured to record initial shadow morphology and an area of the particles in a room temperature state, serving as a reference basis for subsequent area variation analysis after thermal excitation.

In some embodiments, the processor may, after the microplastic sample to be tested has been allowed to stand for settling, turn on the light source, trigger the image sensor chip to expose, and acquire the reference shadow image.

The first preset duration refers to a duration for which the control system applies a low-voltage electrical pulse to the transparent heating electrode. The first preset duration may be determined based on a preset, for example, 0.5 s to 1.5 s.

The low-voltage electrical pulse refers to an electrical signal having a frequency below 1000 Hz, a relatively low voltage amplitude, and presenting characteristics of periodicity or discontinuous abrupt changes. In some embodiments, the frequency of the low-voltage electrical pulse may be determined based on a preset.

The heated shadow image refers to a shadow image acquired at an instant when the low-voltage electrical pulse applied to the transparent heating electrode is cut off. The heated shadow image may reflect the variation in shadow area of the particles after being subjected to instantaneous heating. The microbubbles exhibit a significant increase in shadow area due to internal gas expansion caused by heating, while the solid particles have almost unchanged shadow areas due to extremely small thermal expansion coefficients, thereby allowing the microbubbles to be distinguished from the solid particles.

In some embodiments, the control system may apply the low-voltage electrical pulse lasting 0.5 s to 1.5 s to the transparent heating electrode, thereby instantaneously heating the microplastic sample to be tested (e.g., a suspension) at the bottom of the sample loading region by 2 °C to 5 °C; to avoid interference from electromagnetic and thermal current noise on the image sensor chip, at the instant when the low-voltage electrical pulse is cut off, the image sensor chip is immediately triggered to expose again, and the heated shadow image is acquired.

The plurality of shadows refers to a plurality of granular dark regions contained in the reference shadow image or the heated shadow image. Each shadow corresponds to a particle deposited on the surface of the image sensor chip (e.g., the microplastic particles, the microbubbles, the dust, or the like).

The physical defects, such as dead pixels, micro-scratches, stubborn stains, or the like, generated during a manufacturing or usage process, may be present on the surface of the image sensor chip. The physical defects may form dark artifacts (i.e., physical defect shadows) in the shadow image, which may overlap with the shadows of the particles, thereby causing area calculation distortion. The present embodiment eliminates the physical defect shadows by introducing a background noise reference image.

In some embodiments, the control system may acquire the background noise reference image of the sample loading region; before determining the area variation rate of the plurality of shadows, based on the background noise reference image, eliminate the physical defect shadows on the surface of the image sensor chip in the reference shadow image and the heated shadow image.

The background noise reference image refers to a shadow image that is acquired under a clean state of the sample loading region and characterizes the physical defect on the surface of the image sensor chip.

The physical defect refers to an irreversible inherent physical defect on the surface of the image sensor chip, such as an irreversible hardware defect (e.g., dead pixels, micro-scratches, stubborn stains that cannot be washed away, or the like) generated during the manufacturing or usage process of the image sensor chip itself.

In some embodiments, the control system may acquire the background noise reference image in the following manner: under the clean state of the sample loading region where the microplastic sample to be tested has not yet been dropped, or after cleaning of the sample loading region is completed and cleanliness is verified as qualified, the light source is turned on and the image sensor chip is controlled to acquire a full-field shadow image of the sample loading region, which serves as the background noise reference image. More descriptions regarding the method for rapid detection of microplastic number concentration based on on-chip imaging may be found in following related descriptions.

In some embodiments, the control system may perform spatial coordinate alignment on acquired reference shadow image and heated shadow image with the background noise reference image, respectively; compare and locate dark pixel regions commonly present in the three images, which are the physical defect shadows on the surface of the image sensor chip; and using a background pixel interpolation replacement algorithm, perform pixel coverage and erasure on the physical defect shadows in the reference shadow image and the heated shadow image, thereby achieving elimination of the physical defect shadows and obtaining calibrated reference shadow images and calibrated heated shadow images, which are configured for subsequent accurate extraction of an actual area of the particles.

In some embodiments of the present disclosure, by combining background static denoising with active thermal excitation dynamic identification, physical scratches or stains on the surface of the image sensor chip can be eliminated in advance, which effectively avoids area extraction errors caused by spatial contour overlap between the physical defect shadows and the shadows of the particles, and improves accuracy of determining the actual area of the particles.

The area variation rate refers to a rate used to measure a variation in area of the shadow corresponding to a single particle before and after the single particle is subjected to the low-voltage electrical pulse. In some embodiments, the area variation rate of the shadow may be determined in the following manner: the area variation rate of the shadow=(an area of the shadow in the heated shadow image−an area of the shadow in the reference shadow image)/the area of the shadow in the reference shadow image.

In some embodiments, the control system may control the image processing component to perform spatial coordinate alignment on the reference shadow image and the heated shadow image; extract contour pixels of a same matching shadow in the reference shadow image and the heated shadow image. For a shadow, the control system may determine a difference between the area of the shadow in the heated shadow image and the area of the shadow in the reference shadow image; divide the difference by the area of the shadow in the reference shadow image, thereby obtaining the area variation rate of the shadow. The area of the shadow may be represented by the count of pixels occupied within a shadow contour.

In some embodiments, the control system may control the image processing component to perform aforementioned operations on the calibrated reference shadow image and the calibrated heated shadow image, so as to obtain the area variation rates of the plurality of shadows. Using the calibrated reference shadow image and the calibrated heated shadow image to determine the area variation rates of the plurality of shadows can eliminate the interference of the physical defect shadows on the surface of the image sensor chip with area extraction, avoid area calculation distortion caused by spatial overlap between the physical defect shadows and the shadows of the particles, thereby improving calculation accuracy of the area variation rate and accuracy of microbubble identification.

The preset swelling threshold refers to a threshold value of the area variation rate for distinguishing between the solid particles and the microbubbles. In some embodiments, since the solid particles have an almost unchanged volume under a slight temperature increase (e.g., a temperature rise of 3 °C to 5 °C), while the microbubbles exhibit significant volume expansion due to heating, when the area variation rate of a particle corresponding to a shadow exceeds the preset swelling threshold, the control system may determine that the particle corresponding to the shadow is the microbubble.

In some embodiments, the plurality of shadows may have respective preset swelling thresholds, and the preset swelling threshold may be negatively correlated with the area of the shadow. Since tiny particles are more affected by false area fluctuations caused by pixelation jumps, the smaller the particle size, the higher the corresponding preset swelling threshold may be, and the larger the particle size, the lower the corresponding preset swelling threshold may be.

In some embodiments, the control system may compare the area variation rate of each shadow in the plurality of shadows with its corresponding preset swelling threshold. If the area variation rate of a certain shadow is greater than its corresponding preset swelling threshold, it represents that the particle corresponding to the shadow exhibits significant gas thermal expansion characteristics, which is determined as the microbubble disguised as the solid particle, and in the reference shadow image, the pixels occupied by the microbubble are replaced with surrounding normal background pixels, thereby eliminating the microbubble from the reference shadow image.

In some embodiments of the present disclosure, by using chip-level thin film in-situ thermal excitation means to induce response differences in physical characteristics of the particles, combined with a pre-and-post differential optical shadow area mapping comparison algorithm, the present disclosure breakthroughly achieves precise identification and elimination of microbubble interference, which is a most numerous and most prone to misjudgment in the suspension, by only utilizing image characterization differences of ‘thermo-deformation/displacement’, thereby significantly improving a pre-treatment free direct detection capability for complex samples such as environmental water samples.

In some embodiments, the microplastic sample to be tested is a suspension, and an edge sidewall of the sample loading region is a bilayer anti-adhesion dam. The bilayer anti-adhesion dam includes a bottom hydrophilic isolation layer close to the surface of the image sensor chip, and a chamfered sidewall structure arranged above the bottom hydrophilic isolation layer. The chamfered sidewall structure is inclined outward away from a center of the sample loading region and forms an obtuse angle with a horizontal plane, and an inner surface of the chamfered sidewall structure is coated with a nanometer-scale superhydrophobic coating, thereby allowing the suspension placed in the sample loading region to form a convex meniscus to prevent the suspension from climbing upward along the edge sidewall.

The bilayer anti-adhesion dam refers to a composite liquid barrier structure arranged at a physical boundary of the sample loading region, which includes the bottom hydrophilic isolation layer close to the surface of the image sensor chip, and the chamfered sidewall structure arranged above the bottom hydrophilic isolation layer. In some embodiments, the bilayer anti-adhesion dam is configured to prevent adhesion and climbing of the suspension along a wall surface of the sample loading region.

The bottom hydrophilic isolation layer refers to a hydrophilic layer distributed at a bottom of the bilayer anti-adhesion dam, which is configured to anchor a bottom surface of a droplet, thereby ensuring that a bottom of the suspension may be stably spread on the surface of the image sensor chip.

In some embodiments, the bottom hydrophilic isolation layer may further, when the suspension is instantaneously heated, provide a viscous force (i.e., a Van der Waals force) to adsorb the settled solid particles, preventing the settled solid particles from re-suspending, and ensuring stability of the settled solid particles during a thermal detection process.

The chamfered sidewall structure refers to a structure inclined outward away from the center of the sample loading region and forming the obtuse angle (e.g., 110° to 135°) with the horizontal plane.

In some embodiments, the inner surface of the chamfered sidewall structure is coated with the nanometer-scale superhydrophobic coating (e.g., a polytetrafluoroethylene or the like coating), thereby allowing the suspension placed in the sample loading region to form the convex meniscus to prevent the suspension from climbing upward along the edge sidewall.

The convex meniscus refers to a convexly shaped liquid surface formed when a liquid surface of the suspension is forced to bend downward at an edge under a dual action of an outward-inclined physical barrier of a chamfered sidewall and superhydrophobic repulsion.

In some embodiments of the present disclosure, by providing the bilayer anti-adhesion dam, after the suspension is dropped in, the suspension is firmly adsorbed and anchored by the bottom hydrophilic isolation layer; when the liquid surface rises to contact the chamfered sidewall structure above the bottom hydrophilic isolation layer, since the chamfered sidewall is outwardly inclined and extremely hydrophobic, an edge liquid surface is forcibly ‘pressed downward’, thereby causing the suspension as a whole to form an upwardly convex meniscus with a low edge and a high center. A forcibly formed convexly shaped liquid surface has a surface tension direction opposite to a direction of upward spreading of the suspension along the edge sidewall, which physically cuts off a path of upward climbing of the suspension, and can also inhibit local rapid evaporation of the suspension at the edge.

During a static settling process, the microplastic particles naturally settle solely under gravity, and some microplastic particles may be scattered in an edge region of the sample loading region and unable to enter a central effective imaging region, thereby causing a reduction in detection efficiency. The present embodiment, by controlling the transparent heating electrode to generate the temperature gradient, forms the bottom centripetal flow, and gathers the microplastic particles scattered at the edge to the central effective imaging region.

In some embodiments, the control system is further configured to: during a time period in which the microplastic sample to be tested is allowed to stand, control the transparent heating electrode to heat according to a second preset duration and a preset heating power, so as to form a temperature gradient in the sample loading region where a center temperature is higher than an edge temperature, thereby generating a bottom centripetal flow converging from an edge to the center. The preset heating power is related to a volume of the suspension in the sample loading region.

In some embodiments, the image sensor chip includes the central effective imaging region.

The central effective imaging region refers to a central photosensitive region on the photosensitive surface of the image sensor chip having an optimal signal-to-noise ratio. In some embodiments, the central effective imaging region may be determined based on a geometric center of the photosensitive surface of the image sensor chip and a preset region size (e.g., a rectangular region having a length of 5 mm to 15 mm and a width of 5 mm to 15 mm). Since the central effective imaging region is far away from the edge sidewall of the sample loading region and is unaffected by a shadow of the bilayer anti-adhesion dam and optical distortion of an edge meniscus, the central effective imaging region has an optimal imaging signal-to-noise ratio. A position of the transparent heating electrode is correspondingly arranged with the central effective imaging region, thereby allowing the bottom centripetal flow to gather the microplastic particles to the central effective imaging region.

The preset heating power refers to a heating power dynamically matched and output by the control system according to the volume of the microplastic sample to be tested in the sample loading region. In some embodiments, the preset heating power may be positively correlated with the volume of the suspension in the sample loading region, and a positive correlation coefficient may be determined based on a preset.

In some embodiments, the control system may obtain the volume of the suspension of a current batch dropped onto the sample loading region; determine the preset heating power based on a preset positive correlation coefficient; and set a matched electrical signal based on the preset heating power, to ensure that a stable temperature gradient can be formed under different liquid volume loads. The electrical signal refers to a voltage/current output by the control system to the transparent heating electrode. A value of the electrical signal is proportional to the preset heating power. A matching relationship between the electrical signal and the preset heating power may be determined based on a preset.

The bottom centripetal flow refers to a bottom water flow formed by a convergence of a bottom suspension in the sample loading region (i.e., a layer of suspension close to the surface of the image sensor chip) from surrounding edges of the sample loading region towards the center, which is a water flow generated due to a Marangoni recirculation phenomenon.

In some embodiments, during the time period in which the microplastic sample to be tested is allowed to stand, the processor may continuously supply power to the transparent heating electrode located in the central effective imaging region, thereby causing a temperature of the suspension located in the central effective imaging region to be slightly higher than a temperature of the surrounding edges. Since a liquid surface tension decreases as temperature increases, the suspension located in the central effective imaging region is ‘pulled outward’ by a slightly lower temperature suspension with a high surface tension from surrounding regions, thereby forming a surface water flow diffusing outward from the center. Based on a law of fluid mass conservation, a bottom layer of the suspension in the sample loading region will refill from the surrounding edges along the surface of the image sensor chip towards the center, thereby generating the ‘bottom centripetal flow’. The bottom centripetal flow may apply a persistent centripetal hydrodynamic force to the microplastic particles scattered at a bottom of the edge, and gather the microplastic particles to the central effective imaging region; a flow channel with a ‘wide top and narrow bottom’ formed by the chamfered sidewall structure may cause the bottom centripetal flow to be physically accelerated due to a reduction in cross-sectional area when converging towards the center, thereby enabling efficient sweeping of the microplastic particles at the edge with higher kinetic energy.

In some embodiments of the present disclosure, through a deep-level collaboration between thermal flow control and hardware architecture, the control system utilizes a thermal-induced convection technology of extremely short duration to construct a micro-scale ‘bottom centripetal sweeping flow field’, thereby overcoming a limitation of passive settling solely by gravity. Furthermore, by ingeniously utilizing a ‘funnel acceleration effect’ of an inverted trapezoidal structure on the bottom centripetal flow, the present disclosure ensures that all dispersed microplastic particles in the suspension are ultimately efficiently and rapidly enriched in a core microscopic observation field, thereby maximizing detection efficiency and lower limit accuracy of full-field imaging of a single-frame chip.

### Example 2

FIG. 2 is a flowchart illustrating an exemplary process of a method for rapid detection of microplastic number concentration according to some embodiments of the present disclosure. In some embodiments, the method for rapid detection of microplastic number concentration based on on-chip imaging is executed by the device for rapid detection of microplastic number concentration of EXAMPLE 1, for example, by a processor of a control system 3.

In some embodiments, as shown in FIG. 2, the method includes following steps: step (1), under a clean environmental condition, placing a microplastic sample to be tested on a sample loading region on a surface of an image sensor chip, and allowing the microplastic sample to be tested to stand; step (2), turning on a light source, and acquiring a shadow image of microplastics deposited on a surface of the sample loading region of the image sensor chip as a deposition shadow image; step (3), analyzing the deposition shadow image acquired by a manual analysis manner or a machine learning manner, performing counting and calculating the microplastic number concentration; step (4), dropping anhydrous ethanol onto the sample loading region, wiping off the microplastics deposited on the surface of the sample loading region of the image sensor chip, and acquiring a shadow image of the sample loading region as an inspection shadow image for inspecting cleanliness of the surface of the sample loading region. The cleanliness of the surface of the sample loading region is used for detection of a next batch of microplastic samples to be tested.

More descriptions regarding the microplastic sample to be tested, the image sensor chip, the sample loading region, and the light source may be found elsewhere in the present disclosure (e.g., FIG. 1 and related descriptions thereof).

In some embodiments, in step (1), the microplastic sample to be tested is a suspension, standing time is 90 s or more, the clean environmental condition is a cleanroom or an ultra-clean workbench, and a cleanliness class of the clean environmental condition is Class 100 or above.

The clean environmental condition refers to a clean environment for performing the method for rapid detection of microplastic number concentration. In some embodiments, the cleanliness class of the clean environmental condition may be determined based on an international standard (e.g., ISO 14644).

In some embodiments, mass concentration of the suspension is less than 100 mg/L, and a volume of the suspension added to the sample loading region is 100 μL to 400 μL.

The shadow image refers to a light-dark contrast projection image formed on a photosensitive surface of the image sensor chip after light emitted from the light source is blocked by an object on the surface of the image sensor chip. In the present disclosure, according to different acquisition stages and uses, the shadow image includes a deposition shadow image, an inspection shadow image, a reference shadow image, a heated shadow image, a background noise reference image, or the like.

The deposition shadow image refers to a shadow image of the surface of the sample loading region of the image sensor chip, which is acquired by turning on the light source after the microplastic sample to be tested is allowed to stand for settling. The deposition shadow image contains shadows formed by all objects on the surface of the sample loading region, including shadows of microplastic particles, and possibly existing shadows of microbubbles, shadows of dust, and physical defect shadows on the surface of the image sensor chip, or the like. The shadows of microplastic particles are target objects for subsequent counting analysis, while the shadows of microbubbles, the shadows of dust, and the physical defect shadows are interfering shadows that need to be identified and eliminated (more descriptions regarding a specific elimination process may be found in following related descriptions).

In some embodiments, an acquisition manner of the deposition shadow image is as follows: after the microplastic sample to be tested has been allowed to stand until settling is complete, the control system controls the light source to be turned on, triggers exposure of the image sensor chip, and acquires a full-field-of-view shadow image of the sample loading region, as the deposition shadow image.

The cleanliness refers to a degree of cleanliness of a surface of an object.

In some embodiments, the cleanliness of the surface of the sample loading region may be a particle count of microplastics per square centimeter. The processor may determine the particle count of microplastics in the inspection shadow image to determine the cleanliness of the surface of the sample loading region.

In some embodiments, in step (2), the light source is an LED, and time for acquiring the deposition shadow image is 90 s or more.

The number concentration refers to a count of microplastic particles contained in a unit volume of the microplastic sample to be tested.

In some embodiments, in step (3), the manual analysis manner is to import the deposition shadow image into image processing software, and manually mark and count the microplastics; and the machine learning manner is to automatically recognize and count the microplastics in the deposition shadow image by constructing and training a mathematical model. The mathematical model is a target keypoint detection algorithm based on an existing model and after training and testing. A size of markable or identifiable microplastics is 3 μm to 6 μm. The target keypoint detection algorithm may be a CenterNet algorithm, an HRNet keypoint detection network, a YOLO keypoint detection model, or the like.

The cleanliness of the surface of the sample loading region refers to the degree of cleanliness of the surface of the sample loading region of the image sensor chip after cleaning, and may be represented by a count of the residual particles on the surface of the sample loading region, for judging whether the sample loading region has been cleaned to a state where detection of a next batch of microplastic samples to be tested may be performed.

The inspection shadow image refers to a shadow image acquired after cleaning the sample loading region, for inspecting the cleanliness of the surface of the sample loading region. The inspection shadow image may include residual particle shadows after cleaning and the physical defect shadows on the surface of the image sensor chip. When a count of the residual particle shadows in the inspection shadow image is lower than a preset standard (e.g., a particle count of <10 per cm²), it indicates that the cleanliness of the surface of the sample loading region is qualified and may be used for detection of a next batch of microplastic samples to be tested; if the count of the residual particle shadows exceeds the preset standard, then a cleaning operation of step (4) needs to be repeated until the cleanliness is qualified. The physical defect shadows are an inherent defect of the image sensor chip and are not included in cleanliness determination.

In some embodiments, an acquisition manner of the inspection shadow image is as follows: after wiping the surface of the sample loading region with the anhydrous ethanol in step (4), the control system controls the light source to be turned on, triggers exposure of the image sensor chip, and acquires a full-field-of-view shadow image of the sample loading region, as the inspection shadow image. The processor analyzes the inspection shadow image, determines the count of the residual particle shadows in the inspection shadow image, and compares the count of the residual particle shadows with the preset standard to determine whether the cleanliness is qualified.

In some embodiments, in step (4), the wiping off the microplastics deposited on the surface of the sample loading region of the image sensor chip includes: using a disposable lint-free swab to absorb waste liquid, and then using a dry disposable lint-free swab to wipe the image sensor chip, and the cleanliness of the surface of the sample loading region is a particle count of less than 10 per cm2.

In some embodiments of the present disclosure, the method for rapid detection of microplastic number concentration based on on-chip imaging allows for lensless shadow imaging by directly placing the microplastic sample to be tested on the surface of the image sensor chip, which eliminates the need for a complex optical lens system, and results in a simple operation process and a fast detection speed (image acquisition can be completed after a 90-second static settling period). A large number of microplastic particles can be simultaneously captured and counted in a single-frame full-field-of-view image, thereby greatly improving detection throughput and efficiency. Step (4), through cleaning with the anhydrous ethanol and cleanliness verification, ensures that the surface of the image sensor chip is reusable and reduces a single detection cost, thereby making it suitable for successive batches of high-throughput detection scenarios.

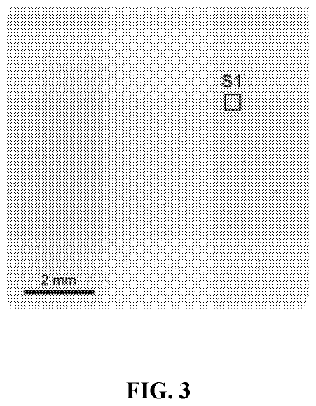

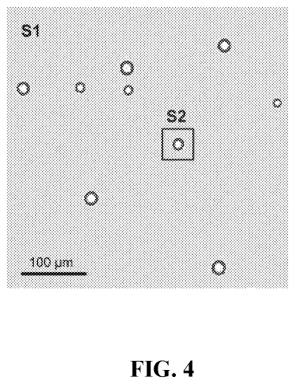

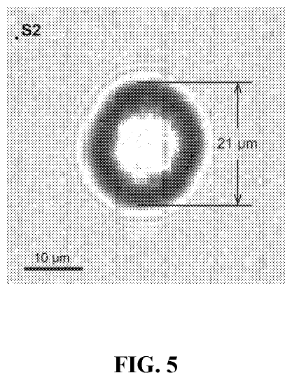

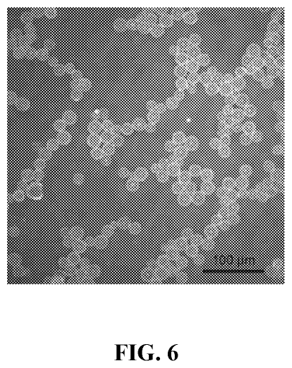

FIG. 3 is a schematic diagram illustrating a lensless shadow microscopy full-field-of-view image of polyethylene microplastics acquired in Example 2 of the present disclosure; FIG. 4 is a partial enlarged view of region S1 in FIG. 3; FIG. 5 is a partial enlarged view of region S2 in FIG. 4; and FIG. 6 is a schematic diagram illustrating a lensed optical microscopic image of polyethylene microplastics acquired in Example 2 of the present disclosure.

In some embodiments, polyethylene microspheres (with a diameter of about 10 μm to 20 μm) are used as a representative of microplastic particles, and a microplastic sample to be tested is subjected to number concentration detection. Steps (1) and (2) may include: weighing 1 mg of polyethylene microspheres, transferring them to a glass bottle, adding 10 mL of an 80% concentration ethanol solution to the glass bottle, mixing uniformly to prepare a 100 mg/L dispersion, using a micro glass pipette to draw 100 μL of the dispersion, quickly loading a drawn dispersion into a sample loading region on a surface of an image sensor chip 2, and after standing for 90 s, turning on a light source 1 and acquiring a deposition shadow image. Results of the deposition shadow image are shown in FIGS. 3-5. Meanwhile, 100 μL of the dispersion is drawn and transferred onto an alumina filter membrane, and a reflective light image of a surface of an alumina filter membrane is acquired at 40× magnification using a reflective light microscope with a lens. Results of the reflective light image are shown in FIG. 6.

By comparing FIGS. 3-6, it can be seen that compared to lensed optical microscopic imaging, lensless shadow microscopic imaging can obtain high-resolution images of individual microplastic particles under a larger field of view.

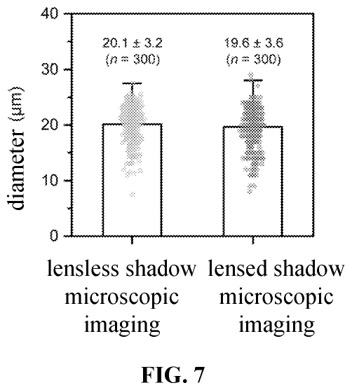

FIG. 7 is a comparison chart of diameter statistical results from lensless shadow microscopic imaging and lensed optical microscopic imaging of polyethylene microplastics in Example 2 of the present disclosure.

In some embodiments, step (3) includes: manually determining a count and the diameter of polyethylene microspheres in acquired shadow images and reflective light images by image processing software (e.g., Adobe Photoshop and ImageJ). Results are shown in FIG. 7. From FIG. 7, it can be seen that there is no significant difference in the diameter of the polyethylene microspheres obtained by the lensless shadow microscopic imaging and the lensed optical microscopic imaging, indicating accuracy of the lensless shadow microscopic imaging, and it can accurately detect number concentration of the polyethylene microspheres.

In some embodiments, in step (3), the number concentration of microplastic particles is determined according to Formula (1):

ρ=N/V (1),

in the Formula (1), ρ is the number concentration of microplastic particles; N is a count of microplastic particles counted in a deposition shadow image, with a unit of count; and V is a volume of a microplastic sample to be tested, with a unit of L. For example, results of repeatedly determining counting of the polyethylene microspheres three times by the image processing software are 605 counts, 586 counts, and 600 counts, respectively. An image processing component 5 may determine the number concentration of the polyethylene microspheres according to Formula (1), and the number concentrations of the polyethylene microspheres are 6.05×106 counts/L, 5.86×106 counts/L, and 6.00×106 counts/L, respectively. A relative standard deviation among three parallel samples is 1.6%, indicating that the method for rapid detection of microplastic number concentration based on on-chip imaging of the present disclosure has high detection accuracy for the number concentration of spherical microplastic particles.

### Example 3

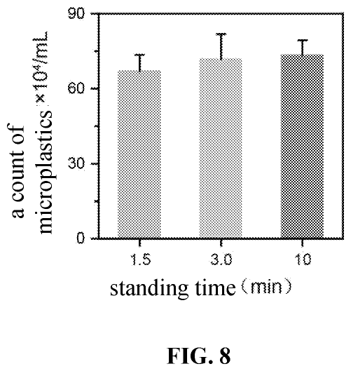

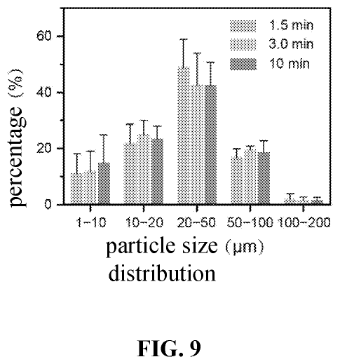

FIG. 8 is a schematic diagram illustrating an effect of standing time on number concentration of melamine microfibers in Example 3 of the present disclosure; FIG. 9 is a schematic diagram illustrating an effect of standing time on a length distribution of melamine microfibers in Example 3 of the present disclosure.

A method for rapid detection of microplastic number concentration based on on-chip imaging in Example 3 is similar to that in Example 2, which will not be described in detail herein. A difference from Example 2 lies in that in Example 3, melamine microfibers (a length of the melamine microfibers is about 1 to 200 μm) are used as a representative for microplastic particles, and number concentration detection is performed on a microplastic sample to be tested. Steps (1) and (2) may include: weighing 1 mg of melamine microfibers, transferring them to a glass bottle, adding 10 mL of an 80% ethanol solution to the glass bottle, mixing evenly to prepare a 100 mg/L dispersion, then diluting the dispersion to 24 mg/L, using a micro glass pipette to pipette 100 μL of the dispersion, rapidly loading a pipetted dispersion onto a sample loading region on a surface of an image sensor chip 2, standing for 1.5 min, 3.0 min, and 10 min, respectively, and then acquiring deposition shadow images; manually counting microfibers (i.e., microplastic particles) in the deposition shadow images via image processing software, then dividing a count of the microfibers by a sample volume (100 μL) to obtain number concentration of the microfibers, results of which are shown in FIG. 8, and determining a length of the microfibers, results of which are shown in FIG. 9.

It can be seen from FIG. 8 that the standing time does not significantly affect the number concentration of the melamine microfibers. It can be seen from FIG. 9 that the standing time does not significantly affect length distribution results of the melamine microfibers. It can be seen that the method for rapid detection of microplastic number concentration based on on-chip imaging of the present disclosure can ensure accuracy of sample image acquisition by standing for 90 s. It can also be seen that the method for rapid detection of microplastic number concentration based on on-chip imaging of the present disclosure greatly reduces detection time compared to tens of minutes for existing automatic optical microscopes, and can achieve rapid detection of microplastic number concentration.

The device and method for rapid detection of microplastic number concentration based on on-chip imaging shown in some embodiments of the present disclosure are applicable to microplastic pure products or samples extracted from environmental media, and can rapidly determine microplastic number concentration. An operation process thereof is simple and easy to promote. Addressing a significant demand for national new pollutant control, the present disclosure greatly shortens imaging time cost of microplastic samples, is characterized by low carbon and energy saving, and responds to energy-saving and low-carbon national policies. The device and method for rapid detection of microplastic number concentration based on on-chip imaging shown in some embodiments of the present disclosure are also applicable to imaging and counting of micron particles other than microplastics.

In continuous batch detection, the surface of the image sensor chip may generate physical defect shadows due to wear and stubborn stains. The physical defect shadows will persist in a plurality of detections and be mistaken for microplastic particles, thereby affecting counting accuracy. The embodiment eliminates the physical defect shadows by acquiring an inspection shadow image after cleaning of a previous batch as a background noise reference image.

In some embodiments, the control system may acquire a historical inspection shadow image acquired through step (4) in a historical detection of the previous batch of microplastic samples to be tested, as a background noise reference image of the sample loading region for a current batch; based on the background noise reference image, the control system may perform image processing on the deposition shadow image acquired in step (2) to eliminate the physical defect shadows on the surface of the image sensor chip, thereby obtaining a preprocessed shadow image.

More descriptions regarding the control system, the microplastic sample to be tested, the deposition shadow image, the image sensor chip, and the physical defect shadows may be found elsewhere in the present disclosure (e.g., FIG. 1 and related descriptions thereof).

The background noise reference image refers to a lensless shadow image acquired under a clean state of the sample loading region and characterizing the physical defect on the surface of the image sensor chip. The background noise reference image is configured to characterize spatial distribution and pixel grayscale characteristics of the physical defect shadows on the surface of the image sensor chip.

In some embodiments, the processor may acquire the historical inspection shadow image acquired in step (4) for the previous batch of microplastic samples to be tested, and use the inspection shadow image that passes verification (e.g., a particle count of less than 10 per cm²) as the background noise reference image of the sample loading region for a current batch. If the processor detects that the current batch is a first detection batch after power-on of the device for rapid detection of microplastic number concentration based on on-chip imaging, then before executing step (1), the processor pre-controls the light source to be turned on and acquires a full-field image of a clean surface of the image sensor chip, and caches the full-field image as the background noise reference image.

In some embodiments, the processor may perform spatial coordinate alignment on the deposition shadow image acquired in step (2) and the background noise reference image; by comparing pixel grayscale at a same coordinate position in the deposition shadow image and the background noise reference image, if a certain shadow exists at the same coordinate position in both images, then the processor determines the certain shadow as the physical defect shadow.

The preprocessed shadow image refers to the deposition shadow image after eliminating the physical defect shadows.

In some embodiments, the processor may utilize an average grayscale value of normal background pixels around the physical defect shadows to perform interpolation replacement (i.e., background smearing) on the physical defect shadows in the deposition shadow image in step (2), thereby outputting a background-uniformized preprocessed shadow image.

In some embodiments of the present disclosure, by introducing the inspection shadow image after cleaning of the previous batch as the background noise reference image, and utilizing image subtraction and smoothing repair technology, the physical defects generated due to wear and stubborn stains after a plurality of uses of the image sensor chip are effectively eliminated, thereby avoiding the physical defects being mistaken for microplastic particles, and greatly improving accuracy of number concentration analysis of microplastic particles and long-term reliability of the device under continuous batch detection.

During a static settling process, in addition to microplastic particles naturally sinking, there may also exist interfering particles in the microplastic sample to be tested, such as microbubbles (rising due to buoyancy) and bottom dust (remaining static), or the like. The shadows formed by the interfering particles in the shadow images are difficult to distinguish from the shadows of the microplastic particles in a single-frame image. The embodiment identifies and eliminates the microbubbles and the bottom dust by continuously acquiring a plurality of frames of images and analyzing motion trajectories of the shadows.

In some embodiments, the control system may, during a time period of allowing the microplastic sample to be tested to stand, control the light source to be turned on, and drive the image sensor chip to continuously acquire a plurality of frames of the deposition shadow image to obtain an image sequence; based on the background noise reference image, eliminate the physical defect shadows in each frame of the deposition shadow image in the image sequence to obtain a target image sequence; based on the target image sequence, extract a gradient contrast feature of a plurality of shadows; based on the gradient contrast feature, determine a motion trajectory type of the plurality of shadows; and in the preprocessed shadow image, eliminate shadows of which the motion trajectory type is the rising trajectory or the static-unchanged state to obtain a purified shadow image. The motion trajectory type includes a rising trajectory, a static-unchanged state, and a sinking trajectory.

The image sequence refers to a collection of the plurality of frames of deposition shadow images continuously acquired at a preset sampling frequency during the time period of allowing the microplastic sample to be tested to stand. The time period of allowing the microplastic sample to be tested to stand may be determined based on an experience preset, such as 90 s. The preset sampling frequency may be determined based on an experience preset, such as 1 Hz.

In some embodiments, the processor may immediately turn on a power supply for the light source when the microplastic sample to be tested starts to statically settle, and send a sampling signal to the image sensor chip to control the image sensor chip to continuously capture the plurality of frames of deposition shadow images according to the preset sampling frequency during the time period of allowing the microplastic sample to be tested to stand, and write the plurality of frames of deposition shadow images into a buffer memory of the processor according to a timestamp, thereby constructing the image sequence.

The target image sequence refers to a collection of the plurality of frames of deposition shadow images after eliminating the physical defect shadows.

In some embodiments, the processor may extract a coordinate set of the physical defect shadows determined in the background noise reference image; for each frame of the deposition shadow image in the image sequence, after performing spatial coordinate alignment on the deposition shadow image, the processor may utilize an average grayscale value of surrounding background pixels at each coordinate position in the coordinate set to perform interpolation replacement (i.e., digital erasure) on pixels at corresponding coordinate positions in the deposition shadow image, thereby eliminating the physical defect shadows in the deposition shadow image; and write the plurality of frames of deposition shadow images after eliminating the physical defect shadows into the buffer memory of the processor according to the timestamp, thereby constructing the target image sequence.

The gradient contrast feature refers to a change trend of a light-dark contrast of a shadow over time in the plurality of frames of deposition shadow images in the image sequence. The light-dark contrast refers to a grayscale difference between a darkest pixel in a shadow region and a background pixel.

In some embodiments, the processor may track a change of each shadow over time in the target image sequence; extract a shadow contrast value of a same shadow in each frame of the deposition shadow image; perform linear fitting on the shadow contrast values of the same shadow according to a time sequence; and use a slope of a fitted straight line as the gradient contrast feature.

The motion trajectory type refers to a qualitative indicator for classifying physical attributes and behavioral patterns of particles corresponding to shadows.

In some embodiments, the motion trajectory type includes the rising trajectory, the static-unchanged state, and the sinking trajectory. The rising trajectory corresponds to microbubbles rising due to buoyancy, the static-unchanged state corresponds to bottom dust that does not generate vertical displacement, and the sinking trajectory corresponds to naturally settling microplastic particles.

In some embodiments, if an absolute value of the gradient contrast feature of the shadow is less than a preset gradient threshold, indicating that sharpness of the shadow has no change over time, the processor may determine the motion trajectory type of the shadow as the static-unchanged state. The preset gradient threshold refers to a preset positive number close to 0.

In some embodiments, if the gradient contrast feature of the shadow is a negative value, indicating that contrast of the shadow decreases over time and the shadow becomes blurred, that is, the particles move away from the image sensor chip, the processor may determine the motion trajectory type of the shadow as the rising trajectory.

In some embodiments, if the gradient contrast feature of a shadow is greater than the preset gradient threshold, indicating that the contrast of the shadow increases over time and the shadow becomes clear, that is, the particles move toward the surface of the image sensor chip, the processor may determine the motion trajectory type of the shadow as the sinking trajectory.

The purified shadow image refers to the shadow image obtained after eliminating the shadows of which the motion trajectory type is the rising trajectory or the static-unchanged state, based on the preprocessed shadow image. The purified shadow image only retains the shadows of which the motion trajectory type is the sinking trajectory. The particles corresponding to the shadows are naturally settling solid particles, including the microplastic particles and high-density impurity particles (e.g., sand and gravel, metal filings, or the like).

In some embodiments, the processor may, based on the motion trajectory type of the shadows, locate the shadows marked as the static-unchanged state and the rising trajectory in the preprocessed shadow image, replace pixels at their corresponding coordinate positions with pixels of a surrounding normal background; retain the shadows marked as the sinking trajectory, and output the purified shadow image.

In some embodiments of the present disclosure, by utilizing a physical characteristic in which the lensless shadow image generates contrast changes as a function of depth in a vertical direction during microplastic sedimentation, and through spatio-temporal serialization tracking, digital decoding of minute motion states of microplastic particles is realized without adding additional hardware or filters, thereby enabling precise identification and filtering out of common interfering particles (e.g., the microbubbles and the bottom dust, or the like), and significantly improving purity of microplastic particle capture and counting in complex environmental media.

Among naturally settling particles, in addition to the microplastic particles, there may also be high-density impurity particles. A sedimentation rate of the high-density impurity particles is significantly greater than that of the microplastic particles, but it is difficult to distinguish the high-density impurity particles and the microplastic particles merely from morphology of a single-frame shadow image. In the present embodiment, a relative sedimentation rate of the particles is determined by analyzing an edge sharpening rate of the shadows, thereby eliminating the high-density impurity particles.

In some embodiments, the control system may, based on the target image sequence, extract the edge sharpening rate of the plurality of shadows; determine the relative sedimentation rate of the plurality of shadows based on the edge sharpening rate; and in the purified shadow image, eliminate shadows of which the relative sedimentation rate exceeds the preset sedimentation threshold.

The edge sharpening rate refers to a rate at which the sharpness of an edge contour of the shadow increases over time in the target image sequence.

In some embodiments, the processor may control the image processing component to utilize an edge detection algorithm (e.g., Canny or Sobel edge detection, or the like) to extract an average gradient magnitude of shadow edges of the shadows in the deposition shadow images after eliminating the physical defect shadows from each frame of the target image sequence. For the shadows determined as being of the sinking trajectory, a slope of change of the average gradient magnitude of the shadow edges of the shadow with increasing time is determined, and the slope of change is taken as the edge sharpening rate.

The relative sedimentation rate refers to a speed at which the particles fall towards a photosensitive surface of the image sensor chip after a size normalization processing. The relative sedimentation rate obtained after the size normalization processing may be used to eliminate an influence of particle size differences on the sedimentation rate, thereby allowing particles of different sizes to compare sedimentation rates of the particles of different sizes under a unified scale.

In some embodiments, the processor may first determine an original sedimentation rate of the particles corresponding to the shadow based on the edge sharpening rate. Then, the processor may extract the pixel size occupied by the shadow in the deposition shadow images after eliminating the physical defect shadows from each frame of the target image sequence. The original sedimentation rates of the plurality of shadows are subjected to the size normalization processing based on the pixel sizes of the plurality of shadows, thereby obtaining the relative sedimentation rates of the plurality of shadows. The size normalization processing refers to compensating for and correcting the original sedimentation rates of different particles according to sizes of different particles, thereby eliminating sedimentation rate differences caused by particle size differences. For example, for the particles with larger pixel sizes, the original sedimentation rate is relatively fast. After the size normalization processing, if the relative sedimentation rate is still abnormally high, it indicates that a particle density of the particle is significantly greater than that of the microplastic particles, and the particle may be the high-density impurity particle.

In some embodiments, the original sedimentation rate is positively correlated with the edge sharpening rate, and a positive correlation coefficient may be determined based on experience.

The preset sedimentation threshold refers to an upper limit reference value of a sedimentation speed used for distinguishing between the microplastic particles and the high-density impurity particles. The preset sedimentation threshold may be preset and determined based on experience.

Since in lensless imaging, a contraction resolution of a particle edge diffraction ring is limited by a ratio of the pixel size of the image sensor chip to a wavelength of the light source, a smaller value of the ratio enables the device to be more sensitive to capturing diffraction texture changes caused by sedimentation of the high-density impurity particles. Therefore, the preset sedimentation threshold is negatively correlated with the ratio of the pixel size of the image sensor chip to the wavelength of the light source. For example, when the wavelength of the light source is fixed, the smaller the pixel size of the image sensor chip used, the appropriately lower the preset sedimentation threshold. When the pixel size of the image sensor chip used is fixed, the larger the wavelength of the light source used, the appropriately lower the preset sedimentation threshold.

In some embodiments of the present disclosure, by considering the situation where diffraction ring resolution is limited by the pixel size in the lensless imaging, a determination logic of the sedimentation speed is linked to an optical sampling limit. For example, when an 0.5 μm ultrafine pixel chip is adopted, the device may automatically lower an edge sharpening tolerance for the sinking trajectory, thereby enabling more sensitive filtering of the high-density impurity particles through the relative sedimentation rate.

In some embodiments, the processor may compare the relative sedimentation rates of the plurality of shadows with the preset sedimentation threshold in the purified shadow image. If the relative sedimentation rate of a certain shadow is greater than the preset sedimentation threshold, it indicates that the particle density corresponding to the shadow is extremely high and sedimentation is too fast. Then, the shadow may be determined as the high-density impurity particle, and the processor may utilize a background pixel replacement manner to erase the shadow from the purified shadow image, thereby filtering out non-microplastic high-density impurity particles.

In some embodiments of the present disclosure, technical advantages of lensless shadow imaging being highly sensitive to vertical depth are fully utilized, transforming an optical physical phenomenon where particle sinking leads to edge sharpening into a three-dimensional kinematic characteristic. Utilizing the particle sedimentation rate to equivalently infer a medium density, the efficient and intelligent elimination of the high-density impurity particles that are difficult to distinguish by optical morphology is achieved without physical separation operations, further ensuring that concentration statistical results uniquely reflect a real pollution status of the microplastic particles.

In the description of the present disclosure, descriptions of reference terms such as ‘an embodiment,’ ‘some embodiments,’ ‘an example,’ ‘a specific example,’ or ‘some examples,’ or the like, mean that the specific features, structures, materials, or characteristics described in connection with the embodiment or example are included in at least one embodiment or example of the present disclosure. In the present disclosure, the illustrative representations of the above terms are not necessarily directed to the same embodiment or example. Furthermore, the specific features, structures, materials, or characteristics described may be combined in any one or more embodiments or examples in an appropriate manner. In addition, without mutual contradiction, a person skilled in the art may combine the different embodiments or examples and the features of the different embodiments or examples described in the present disclosure.

Although the embodiments of the present disclosure have been shown and described above, it may be understood that the above embodiments are exemplary and are not to be construed as limitations on the present disclosure. One of ordinary skill in the art may make changes, modifications, substitutions, and variations to the above embodiments within the scope of the present disclosure.

What is claimed is:

1. A device for rapid detection of microplastic number concentration based on on-chip imaging, wherein the device comprises a light source, an image sensor chip, a control system, and an image processing component; the control system is respectively connected to the light source, the image sensor chip, and the image processing component; the light source is vertically arranged above the image sensor chip; the control system is connected to the image processing component via a data transmission line; a sample loading region is provided on an upper surface of the image sensor chip, and a microplastic sample to be tested is placed in the sample loading region.

2. The device according to claim 1, wherein the light source is monochromatic or polychromatic light, a wavelength of the light source is 300 nm to 700 nm, and a vertical distance from the light source to the image sensor chip is 5 cm to 10 cm.

3. The device according to claim 1, wherein a photosensitive region of the image sensor chip has a length of 10 mm to 20 mm and a width of 10 mm to 20 mm, a pixel size is 0.5 μm to 1 μm, a count of pixels is 100 million to 1.6 billion, and a vertical distance between the microplastic sample to be tested and the image sensor chip is 5 μm to 10 μm.

4. The device according to claim 1, wherein the sample loading region is a square region enclosed by cured adhesive, the sample loading region has a length of 10 mm to 20 mm and a width of 10 mm to 20 mm, a volume of the sample loading region is 100 μL to 400 μL, and a height of the sample loading region is 0.5 mm to 1.5 mm.

5. The device according to claim 4, further comprising a transparent heating electrode arranged at a bottom of the sample loading region, wherein the transparent heating electrode is arranged on the upper surface of the image sensor chip, the transparent heating electrode is electrically connected to the control system, and a refractive index of the transparent heating electrode matches that of a chip cover glass of the image sensor chip so as to allow a light beam of the light source to penetrate without loss;
the control system is further configured to:
after the microplastic sample to be tested has been allowed to stand for settling, turn on the light source to acquire a reference shadow image;
apply a low-voltage electrical pulse of a first preset duration to the transparent heating electrode, and upon stopping application of the low-voltage electrical pulse, control the image sensor chip to acquire a heated shadow image, wherein the first preset duration is 0.5 s to 1.5 s;
determine an area variation rate of a plurality of shadows based on the reference shadow image and the heated shadow image;
eliminate shadows of which the area variation rate is greater than a preset swelling threshold in the reference shadow image.

6. The device according to claim 5, wherein the control system is further configured to:
acquire a background noise reference image of the sample loading region, wherein the background noise reference image is a shadow image that is acquired under a clean state of the sample loading region and characterizes a physical defect on a surface of the image sensor chip;
before determining the area variation rate of the plurality of shadows, based on the background noise reference image, eliminate physical defect shadows on the surface of the image sensor chip in the reference shadow image and the heated shadow image.

7. The device according to claim 5, wherein the microplastic sample to be tested is a suspension, an edge sidewall of the sample loading region is a bilayer anti-adhesion dam, the bilayer anti-adhesion dam includes a bottom hydrophilic isolation layer close to the surface of the image sensor chip, and a chamfered sidewall structure arranged above the bottom hydrophilic isolation layer, the chamfered sidewall structure is inclined outward away from a center of the sample loading region and forms an obtuse angle with a horizontal plane, and an inner surface of the chamfered sidewall structure is coated with a nanometer-scale superhydrophobic coating, thereby allowing the suspension placed in the sample loading region to form a convex meniscus to prevent the suspension from climbing upward along the edge sidewall.

8. The device according to claim 7, wherein the control system is further configured to:
during a time period in which the microplastic sample to be tested is allowed to stand, control the transparent heating electrode to heat according to a second preset duration and a preset heating power, so as to form a temperature gradient in the sample loading region where a center temperature is higher than an edge temperature, thereby generating a bottom centripetal flow converging from an edge to the center, wherein the preset heating power is related to a volume of the suspension in the sample loading region.

9. A method for rapid detection of microplastic number concentration based on on-chip imaging, comprising following steps:
step (1), under a clean environmental condition, placing a microplastic sample to be tested on a sample loading region on a surface of an image sensor chip, and allowing the microplastic sample to be tested to stand;
step (2), turning on a light source, and acquiring a shadow image of microplastics deposited on a surface of the sample loading region of the image sensor chip as a deposition shadow image;
step (3), analyzing the deposition shadow image acquired by a manual analysis manner or a machine learning manner, performing counting and calculating the microplastic number concentration;
step (4), dropping anhydrous ethanol onto the sample loading region, wiping off the microplastics deposited on the surface of the sample loading region of the image sensor chip, and acquiring a shadow image of the sample loading region as an inspection shadow image for inspecting cleanliness of the surface of the sample loading region, wherein the cleanliness of the surface of the sample loading region is used for detection of a next batch of microplastic samples to be tested.

10. The method according to claim 9, wherein in step (1), the microplastic sample to be tested is a suspension, standing time is 90 s or more, the clean environmental condition is a cleanroom or an ultra-clean workbench, and a cleanliness class of the clean environmental condition is Class 100 or above.

11. The method according to claim 10, wherein mass concentration of the suspension is less than 100 mg/L, and a volume of the suspension added to the sample loading region is 100 μL to 400 μL.

12. The method according to claim 9, wherein in step (2), the light source is a light emitting diode (LED), and time for acquiring the deposition shadow image is 90 s or more.

13. The method according to claim 9, wherein in step (3), the manual analysis manner is to import the deposition shadow image into image processing software, and manually mark and count the microplastics; and the machine learning manner is to automatically recognize and count the microplastics in the deposition shadow image by constructing and training a mathematical model, the mathematical model is a target keypoint detection algorithm based on an existing model and after training and testing, and a size of markable or identifiable microplastics is 3 μm to 6 μm.

14. The method according to claim 9, wherein in step (4), the wiping off the microplastics deposited on the surface of the sample loading region of the image sensor chip includes: using a disposable lint-free swab to absorb waste liquid, and then using a dry disposable lint-free swab to wipe the image sensor chip, and the cleanliness of the surface of the sample loading region is a particle count of less than 10 per cm².

15. The method according to claim 9, wherein the method further comprises:
acquiring a historical inspection shadow image acquired through step (4) in a historical detection of a previous batch of microplastic samples to be tested, as a background noise reference image of the sample loading region for a current batch;
based on the background noise reference image, performing image processing on the deposition shadow image acquired in step (2) to eliminate physical defect shadows on a surface of the image sensor chip, obtaining a preprocessed shadow image.

16. The method according to claim 15, wherein the method further comprises:
during a time period of allowing the microplastic sample to be tested to stand, controlling the light source to be turned on, and driving the image sensor chip to continuously acquire a plurality of frames of the deposition shadow image to obtain an image sequence;
based on the background noise reference image, eliminating the physical defect shadows in each frame of the deposition shadow image in the image sequence to obtain a target image sequence;
extracting a gradient contrast feature of a plurality of shadows based on the target image sequence;
determining a motion trajectory type of the plurality of shadows based on the gradient contrast feature, wherein the motion trajectory type includes a rising trajectory, a static-unchanged state, and a sinking trajectory;
eliminating shadows of which the motion trajectory type is the rising trajectory or the static-unchanged state in the preprocessed shadow image to obtain a purified shadow image.

17. The method according to claim 16, wherein the method further comprises:
extracting an edge sharpening rate of the plurality of shadows based on the target image sequence;
determining a relative sedimentation rate of the plurality of shadows based on the edge sharpening rate;
eliminating shadows of which the relative sedimentation rate exceeds a preset sedimentation threshold in the purified shadow image.

18. The method according to claim 17, wherein the preset sedimentation threshold is negatively correlated with a ratio of a pixel size of the image sensor chip to a wavelength of the light source.
